(19) United States
(12) Patent Application Publication
(10) Pub. No.: US 2008/0122923 A1
(43) Pub. Date: May 29, 2008

(54) IMAGING SYSTEM FOR PRODUCING THREE-DIMENSIONAL IMAGE

(75) Inventor: JEN-TSORNG CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/778,518

(22) Filed: Jul. 16, 2007

(30) Foreign Application Priority Data
Nov. 28, 2006 (CN) 200610201156.1

(51) Int. Cl. H04N 13/02

(52) U.S. Cl. 348/44; 348/E13.074

(57) ABSTRACT

An imaging system for producing a three-dimensional image of an object is provided. The imaging system includes a holder, an optical member, first and second camera modules, and an image processor. The holder has a light incident opening. The optical member has a first reflecting surface and a second reflecting surface for reflecting light transmitted through the light incident opening from the object. The first and second camera modules are configured for receiving and converting the light reflected from the respective first and second reflecting surfaces into first and second electronic image signals associated with the object. The image processor is configured for processing the first and second electronic image signals from the first and second camera modules thus producing a three-dimensional image of the object.

### BACKGROUND

1. Technical Field

The present invention relates to imaging systems, and particularly to an imaging system for producing a three-dimensional image.

2. Description of Related Art

With the ongoing development of microcircuitry and multimedia technology, camera modules such as still cameras and digital cameras have entered widespread use. Lens modules and image sensors are key components of the camera modules, however, such a camera module can only pick up a two-dimensional image of an object.

People see stereographs or three-dimensional images of an object by one eye looking from one viewpoint, and the other eye looking from another viewpoint The two eyes are separated by a distance, this leads to a binocular parallax viewing of the object between our two eyes, which our brain can then combine to produce a three-dimensional image in our brain.

In order to reproduce this effect using technology, at least two camera modules would be needed to pick up at least two images to create binocular parallax effect. However, when at least two camera modules are arranged like our eyes in a portable electronic device, the resulting portable electronic device will be bulky and difficult to carry.

What is needed, therefore, is an imaging system, which is more compact and can produce three-dimensional images.

### SUMMARY

In a preferred embodiment, an exemplary imaging system for producing a three-dimensional image of an object is provided. The imaging system includes a holder, an optical member, first and second camera modules, and an image processor. The holder has a light incident opening. The optical member is received in the holder and has first and second reflecting surfaces for reflecting light transmitted through the light incident opening from the object. The first and second camera modules are configured (i.e., structured and arranged) for receiving and converting the light reflected from the respective first and second reflecting surfaces into first and second electronic image signals associated with the object. The image processor is configured for processing the first and second electronic image signals from the first and second camera modules thus producing a three-dimensional image of the object.

In another preferred embodiment, an exemplary imaging system for producing a three-dimensional image of an object is provided. The imaging system includes a holder, an optical member, a first camera module and a second camera module, and an image processor. The holder has a light incident opening. The optical member is received in the holder and has a reflecting surface for reflecting light transmitted through the light incident opening from the object, and a transparent portion for allowing the light to pass therethrough. The first and second camera modules are configured for receiving and converting the light reflected from the reflecting surface and the light passing through the transparent portion into first and second electronic image signals associated with the object. The image processor is configured for processing the first and second electronic image signals from the first and second camera modules thus producing a three-dimensional image of the object.

Other advantages and novel features of the present invention will become more apparent from the following detailed description of preferred embodiment when taken in conjunction with the accompanying drawings.

### BRIEF DESCRIPTION OF THE DRAWINGS

Many aspects of the image system can be better understood with reference to the following drawings. The components in the drawing are not necessarily drawn to scale, the emphasis instead being placed upon clearly illustrating the principles of the present image system. Moreover, in the drawings, like reference numerals designate corresponding parts throughout the several views.

FIG. 1 is a cross-sectional view of an image system according to a first preferred embodiment of the present invention;

FIG. 2 is a cross-sectional view taken along line II-II of the image system shown in FIG. 1;

FIG. 3 is a schematic view of an optical member in an alternative embodiment;

FIG. 4 is an image system according to a second preferred embodiment of the present invention;

FIG. 5 is a schematic view of an optical member in an alternative embodiment; and

FIG. 6 is a schematic view of a portable electronic apparatus using the image system according to a preferred embodiment of the present invention.

### DETAILED DESCRIPTION OF THE PREFERRED EMBODIMENTS

Embodiments of the present image system will now be described in detail below and with reference to the drawings.

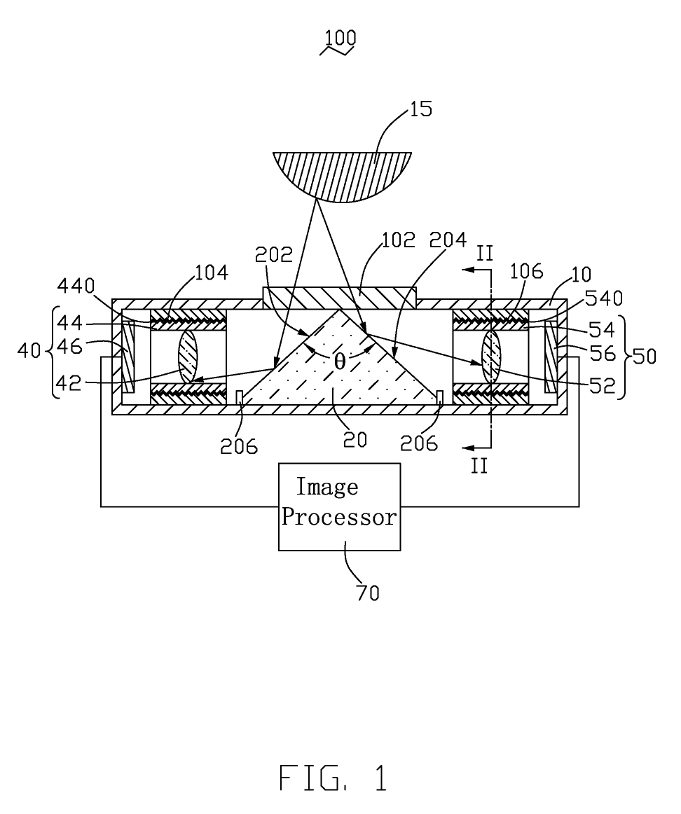

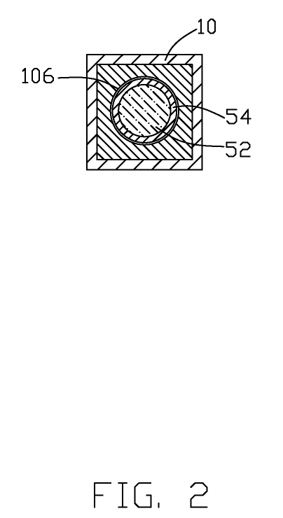

Referring to FIGS. 1 and 2, an exemplary image system 100 according to a first preferred embodiment is shown. The image system 100 includes a holder 10, and an optical member 20, a first camera module 40, a second camera module 50 and an image processor 70 each arranged in the holder 10.

The holder 10 is hollow and has an elongated cuboid shape. The holder 10 has a light incident opening 102 in the middle thereof, and has inner threads 104, 106 at two ends thereof. The optical member 20 is a triangular prism, preferably being an isosceles triangular prism, i.e., an isosceles triangle shape in a cross-sectional view (see FIG. 1). The optical member 20 defines two reflecting surfaces 202, 204 at the respective two side surfaces thereof, and an angle θ between the two reflecting surfaces 202, 204 is an obtuse angle. The optical member 20 is held in the middle of the holder 10 by two blocks 206, and the first camera module 40, the second camera module 50 are co-axially arranged at the respective two ends of the holder 10. The first camera module 40 and the second camera module 50 each include at least one lens 42, 52, a lens barrel 44, 54 for receiving the at least one lens 42, 52, and an image sensor 46, 56 for detecting light from the at least one lens 42, 52. The lens barrel 44, 54 each have outer threads 440, 540 for engaging with the inner threads 104, 106 of the holder 10. The first camera module 40 and second camera module 50 are configured for receiving and converting the light reflected from the respective first and second reflecting surfaces 202, 204 into first and second electronic image signals associated with the object 15.

The image processor 70 connects with the two image sensors 46, 56, and is configured for combining the first and second electronic image signals from the first and second camera modules 40, 50.

When light from an object 15 comes into the light incident opening 102, the two reflecting surfaces 202, 204 of the optical member 20 reflect the light to the respective first camera module 40 and second camera module 50. Due to the obtuse angle θ between the two reflecting surfaces 202, 204, much of the light entering the first camera module 40 will also enter the second camera module 50, such that a part of the first electronic image signal from the first camera module 40 will overlap with a part of the second electronic image signal from the second camera module 50, then the image processor 70 can more easily combine the first and second electronic image signals thereby producing a more perfect three-dimensional image of the object.

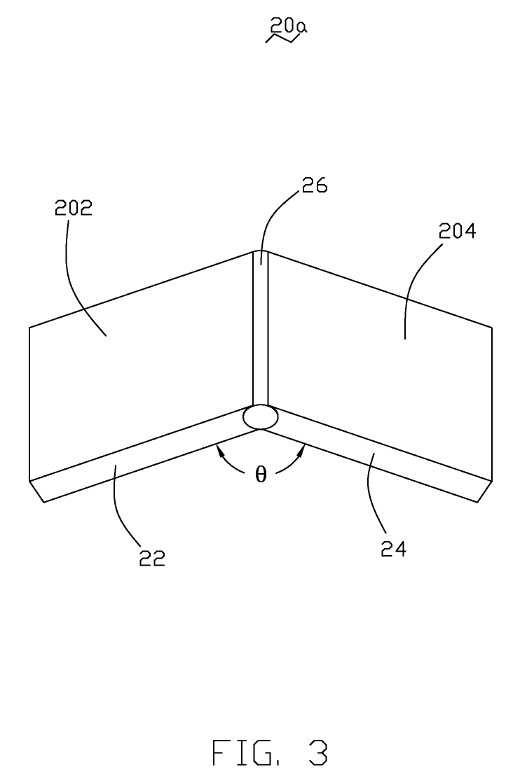

Referring to FIG. 3, alternatively, the optical member 20a is composed of two reflecting mirrors 22, 24, the two reflecting mirrors 22, 24 each have a reflecting surface 202, 204, and the two reflecting mirrors 22, 24 connected with each other by a hinge 26, such that the two reflecting mirrors 22, 24 can have an obtuse angle θ.

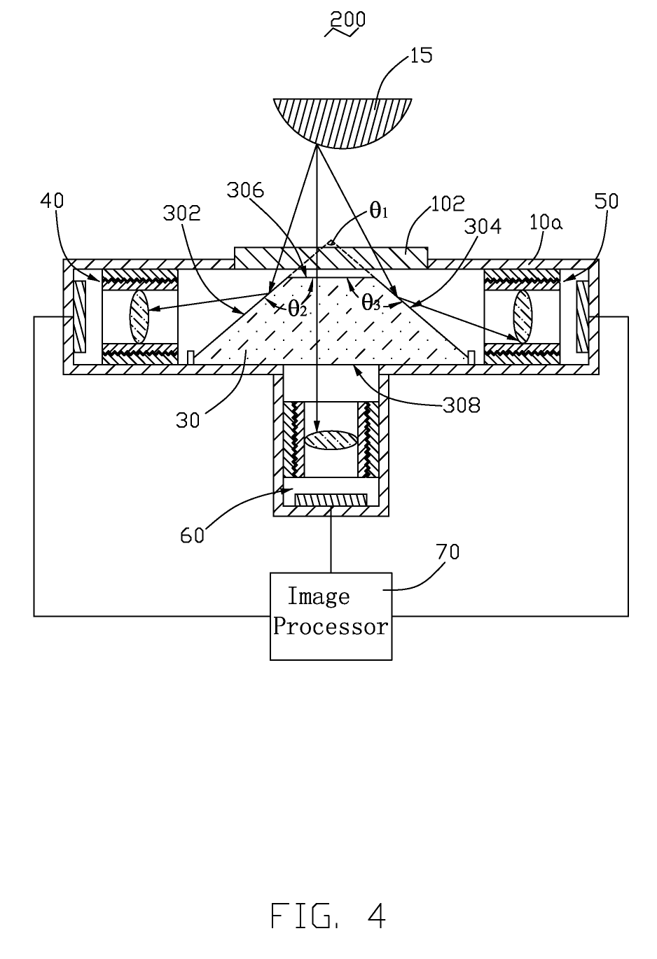

FIG. 4 shows an exemplary image system 200 according to a second preferred embodiment. The image system 200 is essentially similar to the image system 100 illustrated in the first preferred embodiment, however, the image system 200 further includes a third camera module 60, the holder 10a is in a hollow “T” shape, and the optical member 30 is a cone-frustum prism.

The optical member 30 has two reflecting surfaces 302, 304 at two side surfaces thereof, a light incident surface 306 and a light emitting surface 308 parallel to the light incident surface 306. An angle θ₁ between the two reflecting surfaces 302, 304 is an obtuse angle. An angle θ₂ between the reflecting surface 302 and the light incident surface 306, and an angle θ₃ between the reflecting surface 304 and the light emitting surface 308 are also obtuse angles. The first and second camera modules 40, 50 face toward the respective two reflecting surfaces 302, 304. The third camera module 60 is threadedly engaged in the holder 10a, and is aligned with the light emitting surface 308 of the optical member 30. The third camera module 60 is configured for receiving and converting the light transmitted through the transparent portion between the light incident surface 306 and the light emitting surface 308 into a third electronic image signal. The image processor 70 connects with the respective three image sensors of the first, second and third camera module 40, 50, 60 and is configured for combining the electronic image signals from the three camera module 40, 50, 60 thereby producing a more perfect three-dimensional image of the object 15.

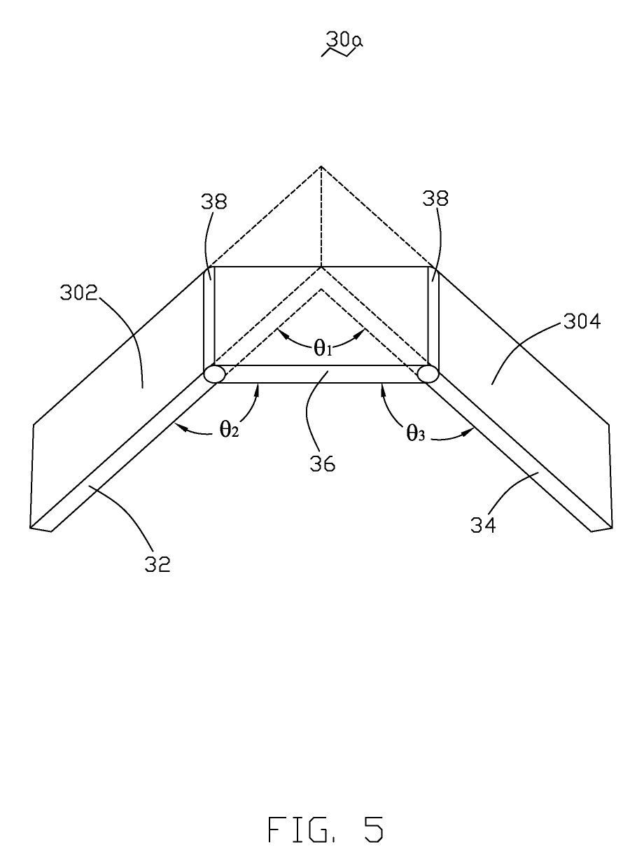

Referring to FIG. 5, alternatively, the optical member 30a includes two reflecting mirrors 32, 34, and a transmitting mirror 36. The two reflecting mirrors 32, 34 each have an reflecting surface 302, 304, and the two reflecting mirrors 32, 34 each connect with the transmitting mirror 36 by a hinge 38. An angle θ₁ between the two reflecting mirrors 32, 34 is an obtuse angle. An angle θ₂ between the reflecting mirrors 32 and the transmitting mirror 36, and an angle θ₃ between the reflecting mirrors 34 and the transmitting mirror 36 each are also an obtuse angle.

It is understood that, in the above second preferred embodiment, when the first camera module 40 is omitted, the third camera module 60 cooperating with the second camera module 50 can also produce a three-dimensional image of the object 15.

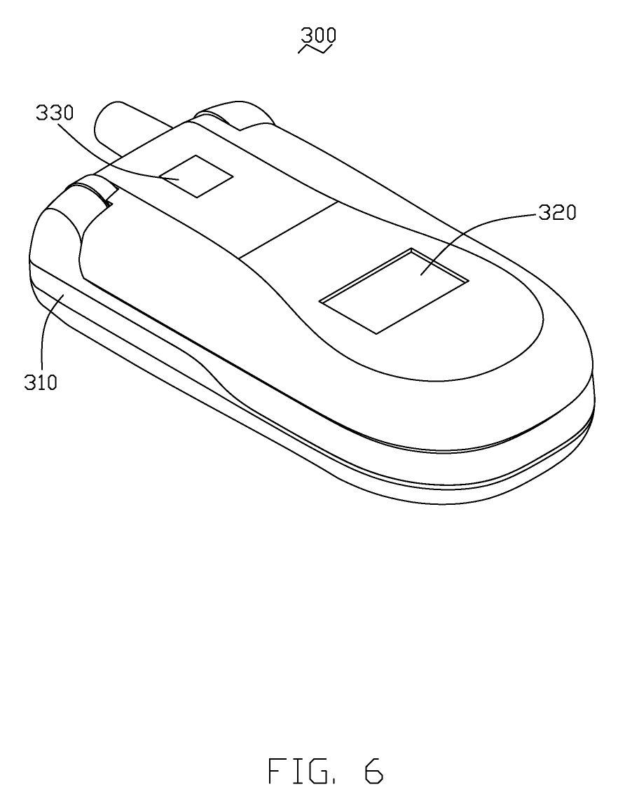

Referring to FIG. 6, an exemplary portable electronic apparatus 300 is shown. The portable electronic apparatus 300 is a mobile phone, which includes a main body 310, a display 320 on the main body 310, and a light incident opening 330 on the main body 310. The image system 100 (see FIG. 1) or the image system 200 (see FIG. 4) is received in the main body 310.

It is understood that, in the above portable electronic apparatus 300, the holder 10, 10a of the image system 100, 200 can be omitted. The portable electronic apparatus 300 may be a different device other than a mobile phone, but also can be a music player and so on.

It is understood that the above-described embodiment are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. An imaging system for producing a three-dimensional image of an object, the imaging system comprising:
a holder having a light incident opening;
an optical member received in the holder, the optical member having first and second reflecting surfaces for reflecting light transmitted through the light incident opening from an object;
a first and second camera modules for receiving and converting the light reflected from the respective first and second reflecting surfaces into first and second electronic image signals associated with the object; and
an image processor for processing the first and second electronic image signals from the first and second camera modules thus producing a three-dimensional image of the object.

2. The imaging system as described in claim 1, wherein the optical member is a prism having the first and second reflecting surfaces, an angle between the first and second reflecting surfaces being an obtuse angle.

3. The imaging system as described in claim 1, wherein the optical member comprises a first and second reflecting mirrors each having the first and second reflecting surfaces, the first and second reflecting mirrors being arranged to form an obtuse angle therebetween.

4. The imaging system device as described in claim 1, wherein the optical member is held in the middle of the holder and faces toward the light incident opening of the holder, the first and second camera modules are arranged in two ends of the holder and face toward the respective first and second reflecting surfaces.

5. The imaging system device as described in claim 1, further comprising a third camera module, the optical member being a prism having the first and second reflecting surfaces, a light incident surface and a light emitting surface parallel to the light incident surface, an angle between the first and second reflecting surfaces being an obtuse angle, the third camera module being configured for receiving and converting the light emitting from the light emitting surface into a third electronic image signal associated with the object.

6. The imaging system device as described in claim 5, wherein an angle between the first reflecting surface and the light incident surface is an obtuse angle, and an angle between the second reflecting surface and the light incident surface being an obtuse angle.

7. An imaging system for producing a three-dimensional image of an object, the imaging system comprising:
a holder having a light incident opening;
an optical member received in the holder, the optical member having a reflecting surface for reflecting light transmitted through the light incident opening from the object, and a transparent portion for allowing the light to pass therethrough;
first and second camera modules for receiving and converting the light reflected from the reflecting surface and the light passed through the transparent portion into first and second electronic image signals associated with an object; and
an image processor for processing the first and second electronic image signals from the first and second camera modules thus producing a three-dimensional image of the object.

8. The imaging system as described in claim 7, wherein the optical member is a prism having a light incident surface, a light emitting surface parallel to the light incident surface, and the reflecting surface, the transparent portion being arranged between the light incident surface and the light emitting surfaces, and an angle between the reflecting surface and the light incident surface being an obtuse angle.

9. The imaging system as described in claim 7, wherein the optical member comprises a reflecting mirror having the reflecting surface, and a transmitting mirror having the transparent portion, an angle between the reflecting mirror and the transmitting mirror being an obtuse angle.
